(19) United States
(12) Patent Application Publication
(10) Pub. No.: US 2011/0146657 A1
(43) Pub. Date: Jun. 23, 2011

(54) DUCT FREE RE-CIRCULATING DOWNDRAFT EXHAUST ACCESSORY

(75) Inventors: VALDIS BRIEDIS, CLEVELAND, TN (US); BRANDON BURNS, ATHENS, TN (US); MICHAEL A. GARVICH, CLEVELAND, TN (US); RUSSELL L. SIMMS, CLEVELAND, TN (US); JEFFREY WARE, CHATTANOOGA, TN (US)

(73) Assignee: WHIRLPOOL CORPORATION, BENTON HARBOR, MI (US)

(21) Appl. No.: 12/643,313

(22) Filed: Dec. 21, 2009

(51) Int. Cl. F24C 3/02; F24C 15/20; H05B 3/68

(52) U.S. Cl. 126/39 E; 126/299 D; 219/443.1

(57) ABSTRACT

An exhaust accessory for a downdraft cooktop includes an air filter cartridge configured to be positioned below a blower of the downdraft cooktop. The air filter cartridge is configured to be in fluid communication with the blower such that air containing cooking vapors may be drawn from a room and advanced into the air filter cartridge prior to being recirculated back into the room.

### TECHNICAL FIELD

The present disclosure relates generally to cooking appliances. The present disclosure relates more particularly to exhaust devices for downdraft cooktops.

### BACKGROUND

A cooking appliance is used to cook meals and other foodstuffs on a cooktop or within an oven. The cooking appliance typically includes an exhaust device for remove cooking vapors such as smoke, grease particles, and odor from the air surrounding the cooktop.

### SUMMARY

According to one aspect, an exhaust accessory for a downdraft cooktop is disclosed. The exhaust accessory includes a housing configured to be fluidly coupled to a downdraft cooktop blower. The housing has an inner chamber defined therein. The exhaust accessory also includes an air filter cartridge positioned in the inner chamber and a laterally-extending rectangular outlet positioned below the air filter cartridge. The air filter cartridge is configured to prevent particulates of a predefined size from passing therethrough. When the exhaust accessory is coupled to the downdraft cooktop air suctioned from a room is advanced through the air filter cartridge prior to being recirculated back into the room through the laterally-extending rectangular outlet.

In some embodiments, the exhaust accessory may further include a flexible hose having an upper end configured to be fluidly coupled to the blower and a lower end fluidly coupled to the housing. In some embodiments, the filter cartridge may be removable from the housing. Additionally, in some embodiments, the housing may have a door secured thereto. The door may be movable between a closed position in which the door prevents user access to the filter cartridge positioned in the inner chamber, and an open position in which user access to the filter cartridge positioned in the inner chamber is permitted. In some embodiments, the exhaust accessory may include a latch configured to maintain the door in the closed position.

In some embodiments, the filter cartridge may include an indicator of filter quality. The indicator may be visible through a slot defined in the housing. Additionally, in some embodiments, the exhaust accessory may include a pair of flanges extending downwardly from the housing on either side of the laterally-extending rectangular outlet.

According to another aspect, a cooking appliance is disclosed. The cooking appliance includes a cooktop including a plurality of cooking areas, a vent opening positioned adjacent to the plurality of cooking areas, a plenum extending downwardly from the vent opening, and a blower fluidly coupled to a lower end of the plenum. The blower may be configured to generate an airflow such that air circulating above the plurality of cooking areas is drawn downward into the vent opening. The cooking appliance includes a filter assembly positioned below the blower and an outlet defined in a lower end of the filter assembly. The filter assembly has an upper end fluidly coupled to the blower. Air draw into the vent opening is advanced downward into the filter assembly prior to being recirculated into the room through the outlet.

In some embodiments, the blower may include an inlet fluidly coupled to the plenum and an outlet fluidly coupled to the air filter assembly. In some embodiments, the blower may further include a variable speed motor positioned between the inlet and the outlet.

Additionally, in some embodiments, the cooking appliance may include a grille positioned over the vent opening. In some embodiments, the cooking appliance may include a cabinet having a countertop spaced apart from a bottom wall, and the cooktop may be coupled to the countertop of the cabinet. In some embodiments, the cabinet may have an inner compartment defined therein between the countertop and a bottom wall, and the filter assembly may be positioned within the inner compartment adjacent to the bottom wall.

In some embodiments, the cabinet may include a base contacting a floor, and the bottom wall of the cabinet may extend outwardly from the base in an orientation parallel to the floor such that a toe kick space is defined between the bottom wall and the floor. Additionally, in some embodiments, the bottom wall may have a rectangular slot extending downwardly therethrough, and the exhaust outlet may be positioned over the slot such that air is ventilated out of the filter assembly through the slot into the toe kick space.

In some embodiments, the filter assembly may include a housing extending from the upper end to the lower end, and a filter cartridge positioned within the housing between the upper end and the lower end, the filter cartridge being configured to prevent particulates of a predefined size from passing therethrough. In some embodiments, a separately-controlled gas burner may be positioned below each of the plurality of cooking areas. Additionally, in some embodiments, an electric heating element may be positioned below each of the plurality of cooking areas.

According to another aspect, a method of removing cooking odors from a cooking area is disclosed. The method includes suctioning cooking vapors from a room into a vent opening positioned adjacent to a plurality of cooking areas of a cooktop, advancing the cooking vapors into an air filter cartridge positioned below the cooktop, and recirculating the filtered air back into the room through an outlet positioned below the air filter cartridge. In some embodiments, recirculating filtered air may include ventilating filtered air from the outlet into a toe kick space defined under a cabinet.

### BRIEF DESCRIPTION OF THE DRAWINGS

The detailed description particularly refers to the following figures, in which:

FIG. 1 is a perspective view of a cooking appliance;

FIG. 2 is a fragmentary front elevation view of the exhaust system of the cooking appliance of FIG. 1;

FIG. 3 is a rear perspective view of the downdraft exhaust device of the exhaust system of FIG. 2; and

FIG. 4 is a cross-sectional side elevation view of the exhaust system of the cooking appliance of FIG. 1.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

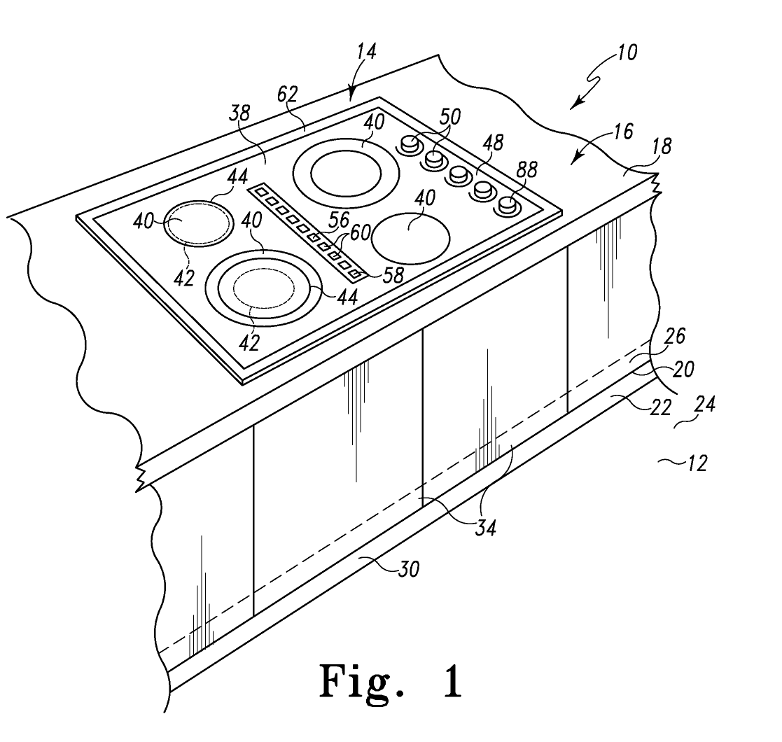

Referring to FIG. 1, a cooking appliance 10 is shown positioned in a kitchen 12. The cooking appliance 10 includes a downdraft cooktop 14 coupled to a cabinet 16. As used herein, the term “downdraft cooktop” refers to a cooktop configured to produce an airflow moving in a generally downward direction. This is distinct from, and in contrast to, a cooktop configured to be used in conjunction with an exhaust hood or fan positioned above the cooktop, each of which is configured to produce an airflow moving in a generally upward direction. One exemplary commercially available downdraft cooktop that may be used as the cooktop 14 is a glass-ceramic JX3 downdraft cooktop, which is commercially available from Jenn-Air® Brand Home Appliances of Benton Harbor, Mich.

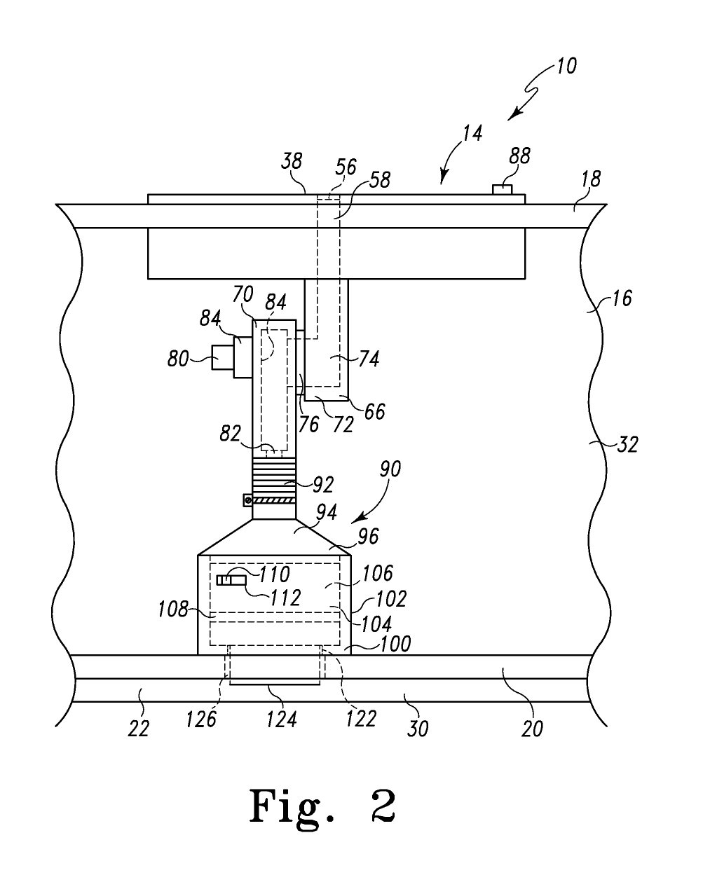

The cooktop 14 is positioned in a countertop 18 positioned on the top of the cabinet 16. The cabinet 16 includes a base 22, which is in contact with a floor 24 of the kitchen 12. A bottom wall 20 of the cabinet 16 extends outwardly beyond a front wall of the base 22 in an orientation that is parallel to the floor 24. In that way, the bottom wall 20 and the front wall of the base 22 define a toe kick space 30 under the cabinet 16. An inner compartment 32 (see FIG. 2) is defined between the bottom wall 20 of the cabinet 16 and the countertop 18. A pair of doors 34 is positioned at the front of the cabinet 16 and permits access to the inner compartment 32.

As shown in FIG. 1, the cooktop 14 includes an upper surface 38 having a plurality of cooking areas 40. An electric heating element 42 is positioned below each of the cooking areas 40. Each heating element 42 is operable to heat its corresponding cooking area 40 to desired cooking temperatures. An outer perimeter line 44 etched into the upper surface 38 designates to the user where the user should place cooking utensils (i.e., pots, pans, and the like) to be heated by each of the cooking areas 40. The cooktop 14 includes a control panel 48 having a number of control knobs 50. A user may separately control the temperature of each of the cooking areas 40 using the knobs 50.

It will be appreciated that in other embodiments the cooktop 14 may include a gas burner positioned below each of cooking areas 40. A grate may be positioned over each of the gas burners such that the grates define the upper surface of the cooktop. In such embodiments, each of the burners is configured to produce a controlled flame that generates a quantity of heat, which may be used to heat cooking utensils positioned on the upper surface. The burners are arranged on the cooktop such that a user can simultaneously heat multiple pots, pans, skillets, and the like.

Returning to FIG. 1, a grille 56 is positioned over a vent opening 58 formed in the upper surface 38 of the cooktop 14. The grille 56, which is positioned in the middle of the upper surface 38 adjacent to each of the cooking areas 40, has a number of slots 60 extending therethrough. Each of the slots 60 permits the passage of air into the vent opening 58 from the region above the cooktop 14. It should be appreciated that in other embodiments the vent opening 58 and the grille 56 may be positioned in other locations adjacent to the cooking areas 40. For example, the vent opening 58 and the grille 56 may be positioned along the back edge 62 of the cooktop 14 or in the countertop 18 of the cabinet 16 to one side of the cooktop 14.

As shown in FIG. 2, the cooktop 14 includes an exhaust plenum 66 positioned in the compartment 32 of the cabinet 16. The plenum 66 is secured to the bottom of the cooktop 14 and is fluidly coupled to a blower 70 at a lower end 72. The plenum 66 has a passageway 74 defined therein that couples the vent opening 58 formed in the upper surface 38 to an inlet 76 of the blower 70. In that way, air entering the vent opening 58 is permitted to advance downwardly through the plenum 66 before passing into the blower 70.

The blower 70 includes an electrically-operated motor 80 positioned between the inlet 76 and an outlet 82. The motor 80 is coupled to a fan 84 that produces an airflow in the blower 70. The motor 80 is configured to operate at low, medium, or high speeds such that the fan produces airflows of different magnitudes. A user may control the speed of the motor 80 using a knob 88 positioned on the control panel 48. As the user rotates the knob 88 to one of a number of “ON” positions, a control switch (not shown) coupled to the knob 88 adjusts the speed of the motor 80 such that airflows of different magnitudes are produced.

The airflow produced by the fan 84 suctions or draws air into the vent opening 58 formed in the upper surface 38 of the cooktop 14. The suctioned air is drawn downward through the plenum 66 and into the inlet 76 of the blower 70. The airflow is then exhausted out the outlet 82 of the blower 70.

A downdraft exhaust device 90 is positioned in the cabinet 16 downstream of the blower 70. The exhaust device 90 includes a flexible transfer hose 92 that fluidly couples the outlet 82 of the blower 70 to the top 94 of a filter housing 96. In that way, gas exhausted by the blower 70 is advanced into the filter housing 96. The filter housing 96 includes a bottom wall 100 contacting the bottom wall 20 of the cabinet 16. A number of sidewalls 102 extend upwardly from the bottom wall 100 to define a filter cavity 104.

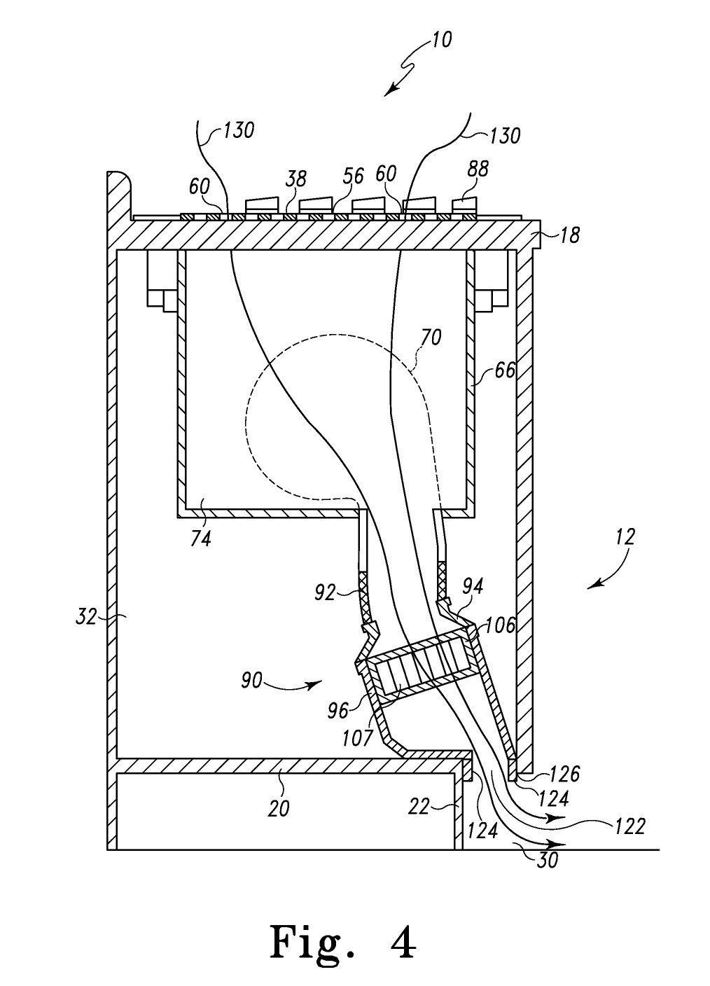

A cartridge 106 is positioned in the filter cavity 104 on a support platform 108. The cartridge 106 includes a filter 107 (see FIG. 4) that is configured to prevent particulates of a predefined size from passing therethrough. The filter is formed from a fibrous material such as paper, foam, or cotton possessing the required filtration capability. An indicator 110 is secured to the cartridge 106 and is visible through a slit 112 formed in one of the sidewalls 102. The indicator 110 allows the user to track the amount of time since the cartridge 106 was installed in the housing 96. In that way, the indicator 110 provides an indication of filter quality.

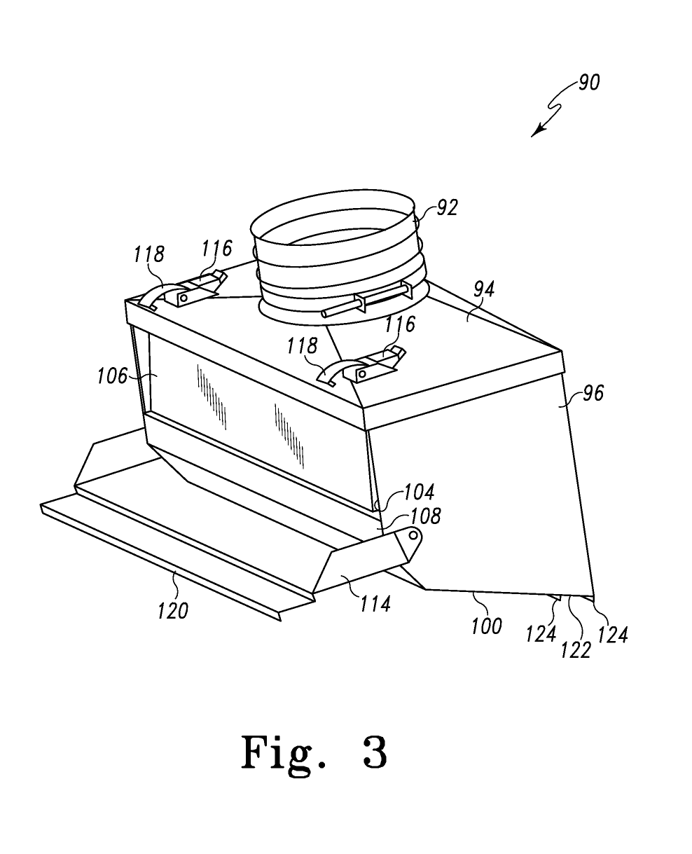

As shown in FIG. 3, an access door 114 is hinged to the lower rear edge of the housing 96. The door 114 permits user access to the filter cavity 104 such that the cartridge 106 may be installed or removed. When in a closed position, the door 114 seals the rear of the housing 96. A pair of latches 116 is secured to the top 94 of the housing 96 on either side of the hose 92. The latches 116 each include a catch 118 that engages with the upper edge 120 of the door 114 to secure the door 114 in the closed position.

A laterally-extending rectangular outlet 122 is defined in the bottom wall 100 of the filter housing 96. A pair of flanges 124 extends downwardly from the bottom wall 100 on either side of the outlet 122. The flanges 124 are received in a laterally-extending slot 126 formed the portion of the bottom wall 20 extending beyond the base 22. In that way, the flanges 124 ensure that the outlet 122 of the filter housing 96 is aligned with the slot 126 of the cabinet 16.

During operation of the cooktop 14, the region above the cooktop 14 may fill with cooking vapors such as smoke, grease, and odor from foods prepared on the cooktop 14. Rotating the knob 88 to one of the “ON” positions causes the blower 70 to begin producing an airflow. A number of arrows 130 shown in FIG. 4 illustrate the flow path of the airflow through the cooktop 14 and the downdraft exhaust device 90. As shown in FIG. 3, cooking vapors are drawn downward through the slots 60 of the grille 56 into the vent opening 58. The vapors advance downward from the vent opening 58 through the plenum 66 and into the blower 70. The vapors are advanced downward through the hose 92 and into the filter housing 96.

Within the housing 96, the vapors advance into the cartridge 106, which, as discussed above, includes a filter configured to prevent the passage of particulates of a predefined size. As such, the filter conditions the vapors such that conditioned air exits the cartridge 106 substantially free of smoke, grease, and odor-carrying particulates. In that way, the downdraft exhaust device 90 eliminates the need for a traditional duct system in which the cooking vapors are advanced from the blower 70 out of the home or dwelling.

Indeed, after exiting the cartridge 106, the conditioned or filtered air is ventilated out of the housing 96 through the rectangular outlet 122. The arrows 130 illustrate that the conditioned air is then recirculated into the kitchen 12 through the toe kick space 30 of the cabinet 16.

As will be appreciated by those of the skill in the art, the cooking appliance 10 may include elements other than those shown and described above. For example the filter housing 96 may include a different outlet configured to be aligned with a different slot formed in the front of the base 22. In that way, the conditioned air may be ventilated through the base 22 into the toe kick space 30 before being recirculated into the kitchen 12. It will also be appreciated that the cooking appliance 10 may also be positioned in other rooms and other locations of a home or other dwelling.

There are a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

1. An exhaust accessory for a downdraft cooktop, comprising:
a housing configured to be fluidly coupled to a downdraft cooktop blower, the housing having an inner chamber defined therein,
an air filter cartridge positioned in the inner chamber, the air filter cartridge being configured to prevent particulates of a predefined size from passing therethrough, and
a laterally-extending rectangular outlet positioned below the air filter cartridge,
wherein when the exhaust accessory is coupled to the downdraft cooktop air suctioned from a room is advanced into the air filter cartridge prior to being recirculated back into the room through the laterally-extending rectangular outlet.

2. The exhaust accessory of claim 1, further comprising a flexible hose having an upper end configured to be fluidly coupled to the blower and a lower end fluidly coupled to the housing.

3. The exhaust accessory of claim 1, wherein the filter cartridge is removable from the housing.

4. The exhaust accessory of claim 3, wherein the housing has a door secured thereto, the door being movable between (i) a closed position in which the door prevents user access to the filter cartridge positioned in the inner chamber, and (ii) an open position in which user access to the filter cartridge positioned in the inner chamber is permitted.

5. The exhaust accessory of claim 4, further comprising a latch, wherein the latch is configured to maintain the door in the closed position.

6. The exhaust accessory of claim 1, wherein the filter cartridge includes an indicator of filter quality, the indicator being visible through a slot defined in the housing.

7. The exhaust accessory of claim 1, further comprising a pair of flanges extending downwardly from the housing on either side of the laterally-extending rectangular outlet.

8. A cooking appliance, comprising:
a cooktop including a plurality of cooking areas,
a vent opening positioned adjacent to the plurality of cooking areas,
a plenum extending downwardly from the vent opening,
a blower fluidly coupled to a lower end of the plenum, the blower being configured to generate an airflow such that air circulating above the plurality of cooking areas is drawn downward into the vent opening,
a filter assembly positioned below the blower, the filter assembly having an upper end fluidly coupled to the blower, and
an exhaust outlet defined in a lower end of the filter assembly,
wherein air drawn into the vent opening is advanced downward into the filter assembly prior to being recirculated into the room through the outlet.

9. The cooking appliance of claim 8, wherein the blower includes an inlet fluidly coupled to the plenum and an outlet fluidly coupled to the air filter assembly.

10. The cooking appliance of claim 9, wherein the blower further includes a variable speed motor positioned between the inlet and the outlet.

11. The cooking appliance of claim 8, further comprising a grille positioned over the vent opening.

12. The cooking appliance of claim 8, further comprising a cabinet having a countertop spaced apart from a bottom wall,
wherein the cooktop is coupled to the countertop of the cabinet.

13. The cooking appliance of claim 12, wherein:
the cabinet has an inner compartment defined therein between the countertop and the bottom wall, and
the filter assembly is positioned within the inner compartment adjacent to the bottom wall.

14. The cooking appliance of claim 13, wherein:
the cabinet includes a base contacting a floor, and
the bottom wall of the cabinet extends outwardly from the base in an orientation parallel to the floor such that a toe kick space is defined below the bottom wall of the cabinet.

15. The cooking appliance of claim 14, wherein:
the bottom wall has a rectangular slot extending downwardly therethrough, and
the exhaust outlet of the filter assembly is positioned over the slot such that air is ventilated out of the filter assembly through the slot into the toe kick space.

16. The cooking appliance of claim 8, wherein the filter assembly comprises:
a housing extending from the upper end to the lower end, and
a filter cartridge positioned within the housing between the upper end and the lower end, the filter cartridge being configured to prevent particulates of a predefined size from passing therethrough.

17. The cooking appliance of claim 8, wherein a separately-controlled gas burner is positioned below each of the plurality of cooking areas.

18. The cooking appliance of claim 8, wherein an electric heating element is positioned below each of the plurality of cooking areas.

19. A method of removing cooking odors from a cooking area, comprising:
suctioning cooking vapors from a room into a vent opening positioned adjacent to a plurality of cooking areas of a cooktop,
advancing the cooking vapors into an air filter cartridge positioned below the cooktop, and
recirculating filtered air back into the room through an outlet positioned below the air filter cartridge.

20. The method of claim 19, wherein recirculating filtered air includes ventilating filtered air from the outlet into a toe kick space defined under a cabinet.
